(19) United States
(12) Patent Application Publication
(10) Pub. No.: US 2020/0167701 A1
(43) Pub. Date: May 28, 2020

(54) SYSTEMS AND METHODS FOR MANAGING THE USE OF FURNITURE ITEMS

(71) Applicants: Michael Debono, Irving, TX (US); Dana Ann Debono, Islip, NY (US)

(72) Inventors: Michael Debono, Irving, TX (US); Dana Ann Debono, Islip, NY (US)

(21) Appl. No.: 16/684,582

(22) Filed: Nov. 14, 2019

Related U.S. Application Data
(60) Provisional application No. 62/767,469, filed on Nov. 14, 2018.

(51) Int. Cl. G06Q 10/02; G06Q 10/10; G06F 9/54; G06K 9/00

(52) U.S. Cl. CPC G06Q 10/02; G06K 9/00201; G06F 9/542; G06Q 10/109

(57) ABSTRACT

Systems and methods of managing use of furniture items, such as lounge chairs, in an area, such as an area including a swimming pool, allow users to reserve furniture items that are at times rearranged. Furniture items are detected in the area, positions of the detected furniture items are determined, and a map of furniture items is generated based on the determined positions. The map of the furniture items is then displayed to a user. Selection of a furniture item is received and a reservation record associated with the selected furniture item is updated to indicate that the furniture item is reserved. A selection of an item to purchase may be received by a first computing device from which a furniture is reserved. In response to the selection of the item to purchase, a message may be transmitted to a second computing device to deliver the selected item to the physical position of the furniture item associated with the first computing device.

### TECHNICAL FIELD

This disclosure relates generally to furniture items (e.g., lounge chairs, tables, umbrellas, etc.) and methods of reserving furniture items in public spaces (e.g., at a swimming pool, on a cruise ship, on a beach, etc.).

### BACKGROUND

Hotels, cruise ships, and beaches typically have a number of furniture items (e.g., lounge chairs, umbrellas, tables, etc.) available for use by individuals (e.g., hotel patrons, passengers, etc.). The number of furniture items available or having a desirable position in a given area, however, is often smaller than the number of individuals desiring to use those furniture items, which often results in individuals attempting to reserve one or more furniture items, for example, by placing a personal item (e.g., a towel, a book, a hat, a shoe, etc.) on (or near) the desired furniture item(s). This reservation method, however, has several deficiencies. For example, this reservation method requires an individual to physically reserve the furniture item, which is typically done early in the morning, and often results in an argument or confrontation when another individual removes the personal item from the “reserved” furniture item so that he or she can use it.

This disclosure addresses these issues by providing systems and methods that allow individuals to remotely and reliably reserve furniture items, such as lounge chairs, tables, umbrellas, and the like.

### SUMMARY

Aspects of this disclosure feature systems and methods for managing the reservation and use of furniture items. One general aspect includes a method of managing use of furniture items in an area. The method includes generating a map of furniture items based on determined physical position information of the furniture items in the area. The method also includes displaying the map; receiving a request to reserve one or more of the furniture items; setting status information in a reservation record associated with the one or more furniture items to a reserved status; and indicating, by an electronic device at the one or more furniture items, the reserved status. Other aspects include corresponding computer systems, apparatuses, and computer programs or applications recorded on one or more computer storage devices, each configured to perform the actions of the methods.

Implementations may include one or more of the following features. The method may include determining that a furniture item is not physically located at the furniture item's position on the map; and, in response to determining that a furniture item is not located at the furniture item's position on the map, transmitting a message to a manager device indicating that the furniture item is not located at the furniture item's position on the map. The method may include detecting one or more additional furniture items in the area; and updating the map to reflect the one or more additional furniture items based on determined physical position information of the one or more additional furniture items.

The method may include displaying input controls to purchase one or more items at a first computing device used to request reservation of a furniture item; receiving input for the purchase of an item of the one or more items at the first computing device; and transmitting a message to a second computing device to deliver the purchased item to the furniture item associated with the first computing device. The method may include detecting that a furniture item is being used by a person; in response to detecting that a furniture item is being used by a user, retrieving reservation information for the furniture item at a current time and determining that a tag of the user is not associated with the reservation information; and, in response to determining that the tag of the user is not associated with the reservation information, transmitting a message that the user is an unauthorized user. The method may include transmitting an unauthorized seat use notification to an electronic device of the furniture item; and controlling, by the electronic device, visual indicia to indicate that there is unauthorized seat use.

The method may include causing the electronic device associated with each of the furniture items to determine the physical position of the electronic device; and receiving physical position information including the physical position of the control device associated with each of the furniture items. The method may include determining that a reservation of a furniture item is cancelled; in response to determining that a reservation of a furniture item is cancelled, transmitting a furniture item unlock message to an electronic device of the furniture item; receiving, by the electronic device, a furniture item unlock message; in response to receiving a furniture item unlock message, indicating, by the electronic device, an unlocked status notification on a notification device of the furniture item; and setting the status information in the reservation record associated with the one or more furniture items to an available status. The notification device may be a display device, and the electronic device may display a visual indicia of the unlocked status notification on the display device.

Generating a map of the furniture items includes generating a map of lounge chairs, seats, tables, food and beverage holders, umbrellas, cabanas, or any combination thereof. The method may further include measuring, by receivers, signal characteristics of a position signal, which is transmitted by the electronic device of a corresponding furniture item; and determining a position of the furniture item corresponding to the electronic device based on the measured signal characteristics and locations of the receivers. The method may include capturing an image of the area; executing an image recognition process on the image of the area to detect the furniture items in the area; and determining the positions of the detected furniture items, respectively, based on a result of executing the image recognition process. The method may include displaying a cost associated with an available time block for using a furniture item; determining an amount of time between a current time and the available time blocks; determining that the amount of time is less than a threshold; and in response to determining that the amount of time is less than the threshold, decreasing the cost associated with the available time block for using the furniture item. The method may include determining that a furniture item is in use by a person; in response to determining that the furniture item is in use, determining that the furniture item is not reserved at a current time; and, in response to determining that the furniture item is not reserved at the current time, creating a reservation of the furniture item for the person. Implementations of the described techniques may include hardware, a method or process, or computer software on a computer-accessible medium.

Another general aspect includes a method of reserving use of a furniture item. The method also includes displaying a map of furniture items generated based on a determined physical positions of furniture items. The method also includes receiving a selection of a furniture item from the furniture items to reserve the furniture item. The method also includes transmitting information regarding reservation of the furniture item by a user to a reservation server, which causes a control device incorporated into the furniture item to display a reserved status of the furniture item. Other aspects include corresponding computer systems, apparatus, and computer programs recorded on one or more computer storage devices, each configured to perform the actions of the methods.

Implementations may include one or more of the following features. The method may include receiving input for the purchase of an item of the one or more items; and transmitting a message to a remote device to deliver the purchased item to the physical position of the reserved furniture item. Implementations of the described techniques may include hardware, a method or process, or computer software on a computer-accessible medium.

Another general aspect includes a system for managing use of furniture items in an area. The system also includes furniture item communication devices and electronic devices disposed on furniture items, respectively, in the area, the electronic devices configured to indicate a status of the respective furniture items. The system also includes beacons distributed throughout the area, each beacon being configured to receive a position signal from each of the furniture item communication devices, respectively. The system also includes a server in communication with the beacons, the server may include a processor and a memory storing instructions, which, when executed by the processor, causes the server to: determine positions of the furniture items, respectively, in the area based on the position signals; generate a map of the furniture items based on the determined positions; transmit the map and current reservation information to a user device; and receive updated reservation information from the user device. Also, the server causes one or more electronic devices of one or more respective furniture items to indicate that the one or more furniture items are reserved. Other aspects include corresponding computer systems, apparatus, and computer programs recorded on one or more computer storage devices, each configured to perform the actions of the methods.

Implementations may include one or more of the following features. The current reservation information may include furniture items that are currently used and furniture items that are reserved. The memory may include instructions, which, when executed by the processor, further cause the server to: determine that the nonuse signal is received for greater than a predetermined period; and in response to determining that the nonuse signal is received for greater than a predetermined period, cancel the reservation associated with the furniture item corresponding to the furniture sensor transmitting the nonuse signal. The memory may include instructions, which, when executed by the processor, further cause the server to: receive an order to purchase one or more items from a first client device; process the order; and determine the furniture item associated with the first client device and transmit a message including the position of the furniture item to a second client device. Implementations of the described techniques may include hardware, a method or process, or computer software on a computer-accessible medium.

Aspects of this disclosure may feature a system of one or more computers that can be configured to perform particular operations or actions by virtue of having software, firmware, hardware, or a combination of them installed on the system that in operation causes or cause the system to perform the actions. One or more computer programs or applications running on a suitable computing device can be configured to perform particular methods, operations, or actions disclosed herein by virtue of including instructions that, when executed by a data processing apparatus, cause the apparatus to perform the methods, operations, or actions.

### BRIEF DESCRIPTION OF THE DRAWINGS

The disclosure is best understood from the following detailed description when read in conjunction with the accompanying drawings. It is emphasized that, according to common practice, the various features of the drawings may not be to scale, and the dimensions of the various components may be arbitrarily expanded or reduced for clarity.

FIG. 1 is a block diagram of a reservation system according to aspects of this disclosure;

FIG. 2 is a block diagram of the backend system of FIG. 1 according to an aspect of this disclosure;

FIG. 3 is a block diagram of the control device of FIG. 1 according to an aspect of this disclosure;

FIGS. 4A and 4B are block diagrams illustrating how beacons are used to generate a map of the furniture items according to aspects of this disclosure;

FIGS. 5-8 are flow diagrams of methods of managing use of furniture items according to aspects of this disclosure;

FIG. 9 is a perspective view of a smart lounge chair according to an aspect of this disclosure;

FIG. 10 is a front view of an electronic module of the smart lounge chair of FIG. 9;

FIG. 11 is a block diagram illustrating the connection of the electronic module to a system module; and

FIGS. 12A and 12B are diagrams of user interfaces for reserving furniture items disposed around a swimming pool according to aspects of this disclosure.

### DETAILED DESCRIPTION

This disclosure describes a reservation system, whereby a user may reserve outdoor furniture items via the reservation system. Outdoor furniture items may refer to lounge chairs, deck chairs, outdoor tables, umbrellas, and the like. For example, a user may use the reservation system to reserve a lounge chair by a pool, on a beach, on a cruise ship, at a country club, or the like. The outdoor furniture items are not limited to something on which a person may sit. For example, the outdoor furniture item may be a table or an umbrella. The outdoor furniture items may include any paraphernalia used at a pool, on a beach, on a cruise ship, or at a country club to improve the user's experience. For example, the furniture item may include a tent, a sunshade, a food or beverage holder, a blanket, or a towel. The outdoor furniture item may include any item placed within a subarea reserved by a user. In aspects, the reservation system is further configured to generate a site map of seating, such that as lounge chairs and deck chairs are moved around, the reservation system may determine the locations of the seats with respect to an area (e.g., a pool deck or beach).

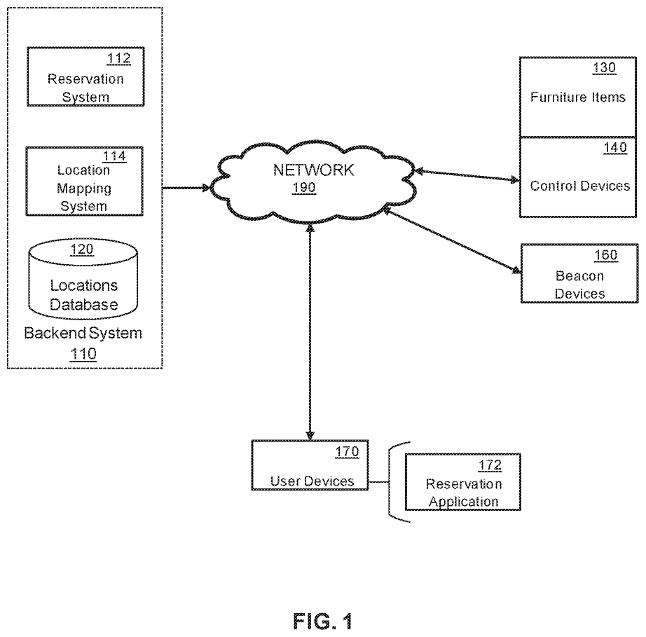

FIG. 1 illustrates an example reservation system 100. In aspects, the reservation system 100 includes a backend system 110, furniture items 130, control devices 140, beacon devices 160 (or “beacons”), and user devices 170 that execute or otherwise access a reservation application 172. As used herein, a seat may refer to a deck chair, a lounge chair, an outdoor table, an umbrella or the like. It is understood that while a user does not sit in a table or umbrella, a user may sit around a table or under an umbrella. Thus, such “seats” may be reserved even though one does not sit on them.

A control device 140 may be a device that includes or controls a visual indicator (e.g., a light, an LED screen that displays messages, or the like) that displays a reservation status of a respective furniture item 130. For example, a user may reserve a furniture item 130 at a pool or beach via the backend system 110. In response to the user reserving the furniture item 130, the control device 140 may display an indicia (e.g., a red light, which may be generated by a red or a multicolored light-emitting diode (LED), a message on an liquid crystal display (LCD) screen of the control device 140, or the like) that indicates that the seat is reserved. When the user arrives at the seat, the user may claim the seat. In aspects, the user may use a user device 170 to verify that the user has arrived (e.g., via geolocation or pairing, such as via Bluetooth, between the control device and the user device 170). In aspects, the control device 140 may display an indicia indicating that the furniture item 130 is claimed by the rightful user (e.g., a green light, a message on an LCD screen, or the like). In some aspects, the control device 140 may display another indicia (e.g., a yellow light, which may be generated by a yellow or a multicolored light-emitting diode (LED), a message on an LCD screen of the control device 140, or the like) to indicate that a furniture item 130 is not reserved, and therefore usable by the general public.

In some aspects of the disclosure, the control device 140 may be integrated into the furniture item 130 itself (e.g., the control device 140 may be non-removably connected to the furniture item 130). In other aspects, the control device 140 may be independent of any furniture item 130 and may be removably coupled to a furniture item 130 or otherwise affixed to the furniture item 130. For example, the control device 140 may be configured as a standalone module with an indicator (e.g., an LED display) configured to provide various information, such as, for example, an identity of the particular furniture item 130, whether the furniture item 130 is reserved or not reserved, information pertaining to an identify of the reserving party, etc. In these aspects, the control device 140 is described separately as being connectable or attachable to an existing furniture item 130.

In aspects, each control device 140 may be associated with a respective furniture item 130 and may be assigned a unique device ID that identifies the control device 140 from other control devices 140 and, thus, the furniture item 130 from other furniture items 130. Thus, by way of association, each furniture item 130 may be uniquely identified by the device ID of the control device 140 that is associated therewith. In this way, the status of a furniture item 130 may be maintained and monitored by the backend system 110. For example, if a furniture item 130 is said to be reserved for a period of time, the reservation may be recorded using the device ID of the control device 140 with which the furniture item 130 is associated. Similarly, if a furniture item 130 is being used without a reservation (e.g., a pool or beach goer sat at an unreserved chair), the status of the device ID of the control device 140 associated with the seat may be recorded as “in use”.

This disclosure also describes various architectures that may be used to support the reservation of one or more furniture items 130. For example, in implementations, an individual may wirelessly reserve one or more furniture items 130, such as through an application. The application may be a website (e.g., a hotel website), a mobile application executed on a user device 170, or a web application. In aspects, the application may provide the individual with a map or layout illustrating the location of one or more furniture items 130 in an area (e.g., a pool deck) and the reservation status of each furniture item 130 (e.g., whether the furniture item 130 is reserved or unreserved at a given time). Through the application, the individual can then select one or more furniture items 130 for reservation, which may then be identified as “unavailable” to subsequent users of the application.

In aspects, the backend system 110 manages furniture item 130 reservations. The backend system 110 may manage the furniture item 130 reservations for a single location (e.g., a hotel or a beach club), multiple locations of a single entity (e.g., a hotel chain), or multiple locations on behalf of multiple entities (e.g., third party hotel chains or beach club operators). In aspects, the backend system 110 interfaces with software application instances, whereby each software application instance is hosted on or otherwise accessed via a user device 170 of a respective user. In other aspects, the backend system 110 may be implemented on a server which establishes a communication session with a software application instance running on the user device 170, which may be a smartphone or tablet.

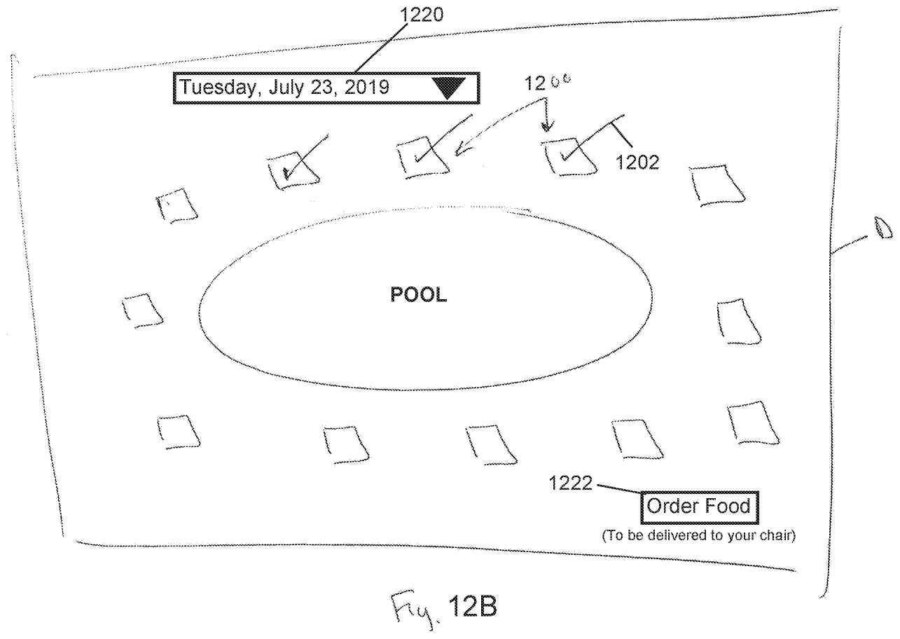

In aspects, the user may use the application to reserve a furniture item 130 (or multiple furniture items). For example, an application running on a user's device (e.g., a smartphone, a tablet computer, or a laptop computer) may display the user interface illustrated in FIG. 12A on the touchscreen of the user's device and the user may touch a representation of a furniture item 1200 on the user interface on a desired date, which is selected by operating the pull-down menu 1220, and during a desired one of the time blocks 1210, which is indicated as selected by the dotted box around one of the time blocks 1210, to reserve the furniture item 130. As another example, an application running on a user's device may display the user interface illustrated in FIG. 12B on the touchscreen of the user's device and the user may touch a representation of an available furniture item 130 on the user interface on a desired date to reserve the furniture item 130.

In some of these aspects, the user may select or provide a date and/or time the user wishes to reserve a seat. In response, the backend system 110 may provide a list of available furniture items 130 that are available at the requested date and/or time. In some of these aspects, the backend system 110 may provide a location map indicating the locations of each furniture item 130 and the status of each seat at the given time (available or reserved). For example, the location map may show the furniture items 130 with respect to a pool deck or beach front. The user may select one or more available furniture items 130 for reservation. In response, the backend system 110 may record the reservation. In recording the reservation, the backend system 110 may create a reservation record, that indicates the device ID associated with the seat, the user ID of the user making the reservation, and the date and time or time block of the reservation.

In aspects, the backend system 110 may be configured to manage the statuses of the furniture items 130. In aspects, the backend system 110 may transmit notifications to each respective control device 140 that indicates a status of the respective seat (e.g., reserved, available to the public, or in use). In some aspects, each control device 140 may communicate with the backend system 110 via an application programming interface (API). In aspects, a control device 140 may request its reservation status from the backend system 110 via the API. In response, the backend system 110 may look up the current reservation status of a seat and may provide the status to the API. If the current status of a furniture item 130 has changed, the control device 140 may update the visual indicator to indicate the new status of the corresponding furniture item 130 (e.g., from “available” to “reserved” or vice versa).

In some aspects, the backend system 110 receives a notification from a user device 170 of a user with a reservation indicating that the user has arrived to their seat. For example, upon arriving to a reserved seat, the user may “unlock” the seat via the user device 170. In some of these example aspects, the user may pair the user device 170 with the control device 140. In other example aspects, the user device 170 may establish a connection with the backend system 110, which may be implemented in a server, and request that a seat be “unlocked”. In other example aspects, the user may select a graphical user interface element (e.g., a button) on the application indicating that he or she has arrived. In response to the user arriving, the backend system 110 may change the status of the seat to “occupied”. In some aspect, the control device 140 may update the visual indicator to indicate the new status of the seat (e.g., from “reserved” to “occupied”).

It is also envisioned that the user device 170 may be embodied as a user's personal key card (e.g., supplied by a hotel to allow the user to gain access to the user's hotel room or quarters). In such aspects, it is envisioned that the control device 140 may be configured to communicate with the user device 170 (e.g., the key card) such that the corresponding furniture item(s) 130 may be “unlocked” by associating the user device 170 with the control device 140 (e.g., by bringing the user device 170 into proximity and/or contact with the control device 140). In some aspects, a reservation application used by a user to reserve one or more furniture items 130 may automatically contact or access a hotel's computer system to enable the user's key card to unlock the reserved one or more furniture items 130 using the user's information contained in the user's device running the furniture item reservation application. If needed, the reservation application may request the user's hotel reservation information in order to properly interface with the hotel's computer system. In other aspects, the user device 170 may be an identification card, a smartcard, a credit card, or any device capable of communicating or otherwise interfacing with the control device 140 to “unlock” the furniture item 130.

In aspects, the backend system 110 works in conjunction with the control devices 140 (which may be referred to generally as electronic devices) to maintain a location map of a seating area (e.g., pool deck, beach, etc.). As furniture items 130 may be moved by employees or guests, the locations of the furniture items 130 with respect to one another may change. In such instances, a user may have reserved a furniture item 130 in a particular location with respect to an area (e.g., a spot on one side of the pool or the front row on a beach). As the furniture items 130 may be moved, the specific physical furniture item 130 (e.g., lounge chair) normally associated with a particular location may actually be located otherwise at a different area. In aspects, the backend system 110 may utilize the location map to selectively reassign a reservation to a different furniture item 130, so as to maintain the same or a similar location as the reserved location.

In aspects, the backend system 110 may determine the location of furniture items 130 using known locations of beacon devices 160 and signal strength measurements captured by each respective control device 140. Examples of beacon devices 160 can include wireless hubs, Bluetooth transmitters, Bluetooth low energy transmitters, and the like. The beacon devices 160 may be used to facilitate communication between the control devices 140 and the backend system 110 (e.g. via a communication network) or may be used only for a multilateration or trilateration process to determine the positions of the furniture items 130. In these aspects, each area may have a sufficient number of beacon devices 160 (e.g., two, three, or more Bluetooth beacons or WIFI beacons), such that each backend system 140 may be within communication of at least two beacons. In these aspects, the beacons may be in fixed and/or known locations.

Each control device 140 may include one or more communication modules (e.g., Bluetooth, WIFI, Bluetooth Low Energy chipsets) that communicate with the beacon devices 160. In some aspects, the communication modules may output a detected signal strength from each respective beacon device 160. In aspects, a backend system 140 may use these detected signal strengths to triangulate the position of the furniture items 130 with respect to the beacon devices 160. In other aspects, the control devices 140 communicate the determined signal strengths to the backend system 110 (e.g., via the beacon devices 160 or a wireless router), which, in turn, triangulates the position of the furniture items 130. In aspects, a control device 140 and/or a backend system 110 may leverage lookup tables and/or a triangulation function that calculates a position of a furniture item 130 relative to three or more beacon devices 160 based on the respective locations of the beacon devices (e.g., geolocations relative to a fixed point, or relative to one another) and the measured signal strengths.

In other aspects, the beacon devices 160 may be replaced with one or more cameras. The one or more cameras may be disposed in such a way as to obtain an image of an entire area in which furniture items 130 may be placed. After the one or more cameras capture one or more images of the area, the backend system 110 obtains the one or more images and processes the one or more images with an image recognition algorithm to detect furniture items 130 in the area. Then, the backend system 110 determines the positions of the detected furniture items 130 based on the positions of the detected furniture items 130 with respect to dimensions of the area.

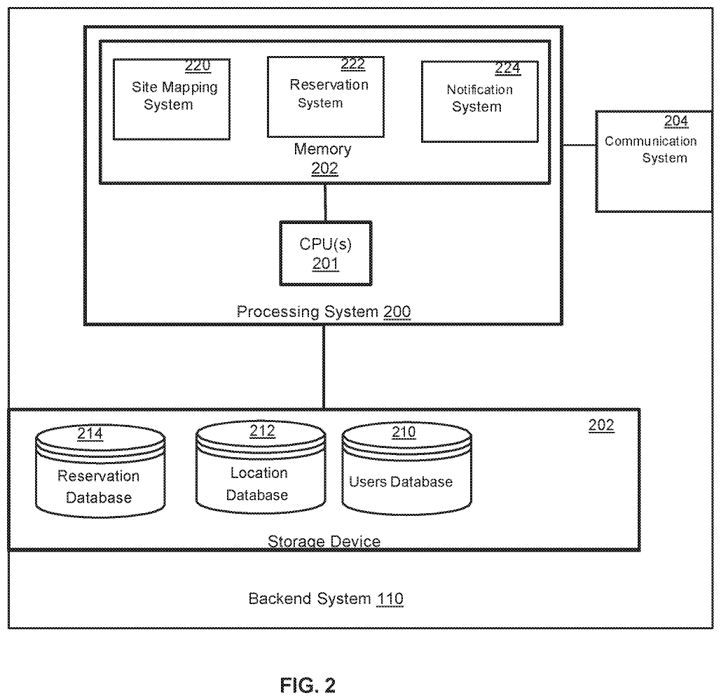

FIG. 2 illustrates an example set of components of a backend system 110. In aspects, the backend system 110 may be executed by a set of one or more physical servers and/or by a cloud computing infrastructure. The backend system 110 may include a processing system 200, a storage system 202, and a communication system 204.

The storage system 202 includes one or more storage devices. The storage devices may include persistent storage mediums (e.g., flash memory drive, hard disk drive) and/or transient storage devices (e.g., RAM). The storage system 202 may store one or more data stores. A data store may include one or more databases, tables, indexes, records, file systems, folders and/or files. In the illustrated aspects, the storage device stores a user data store 210 that stores user-related data (e.g., user records that relate user accounts to reservations), a location data store 212 that stores location-related data (e.g., location maps), and a reservation data store 214 that stores reservation related data (e.g., reservation records). A storage system 202 may store additional or alternative data stores without departing from the scope of the disclosure.

The processing system 200 may include one or more processors 201 and a memory 202. The one or more processors 201 may operate in an individual or distributed manner. The processors 201 may be located in the same physical device and/or location or may be distributed across multiple devices and/or locations. In aspects, the one or more processors 201 of the processing system 200 may execute instructions that implement a site mapping system 220, a reservation management system 222, and/or a notification system 224. The instructions that implement the site mapping system 220, the reservation management system 222, and/or the notification system 224 may be stored in the memory 202.

The communication system 204 may include one or more transceivers that are configured to effectuate wireless or wired communication with one or more external devices. The communication system 204 may implement any suitable communication protocol. The communication system 204 may implement, for example, an IEEE 801.11 wireless communication protocol and/or any suitable cellular communication protocol to effectuate wireless communication with external devices via a wireless network. The communication system 204 may implement wired communication protocols, such as suitable LAN protocols.

In aspects, the site mapping system 220 is configured to generate a map of a site, e.g., a swimming pool deck or a beach area, based on mapping information, e.g., measured (determined) positions of the furniture items 130 at the site.

In aspects, the reservation system 222 is configured to present current reservation information to a client device, receive new reservation information from the client device, and update the current reservation information with the new reservation information.

In aspects, the notification system 224 is configured to, among other things, notify a user device 170 or a management device of the status of a furniture item 130, e.g., the reservation status. The management device may be a computer that resides in or is used in, for example, a main hut on a pool deck or in a reception area. The computer may run an application that shows a real-time view of the map of furniture items 130. In response to detecting the nonuse of a furniture item 130 during a portion of a time block when the furniture item 130 is reserved, the notification system 224 may notify the management device of the nonuse status of the furniture item 130 and allow the user of the management device to cancel the reservation. As another example, in response to receiving an order for a food or beverage from a client device, the notification system 224 may notify the management device of the location of the furniture item 130 associated with the client device so that the food or beverage may be delivered to the appropriate user.

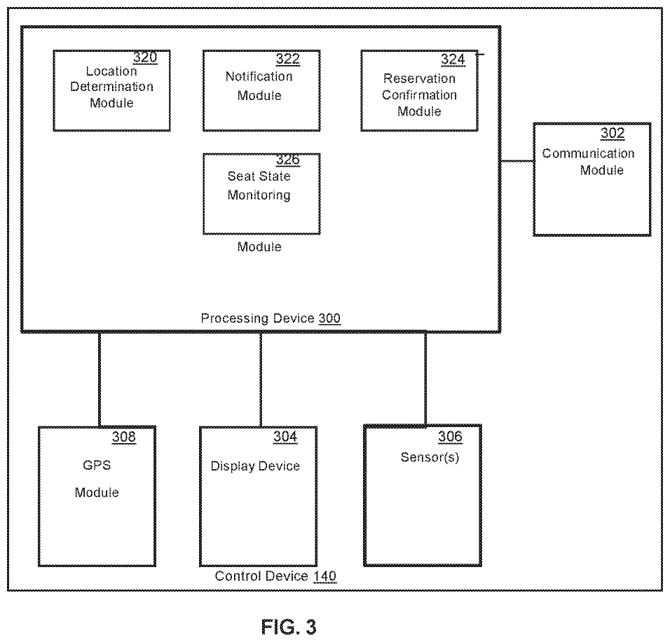

FIG. 3 illustrates an example set of components of a control device 140. In aspects, the control device 140 may include a processing device 300, a communication unit 302, and a user interface 304 (e.g., a display device, an LED, a touchscreen, or the like). In some aspects, the control device 140 may further include one or more sensors 306 and/or a GPS module 308. The one or more sensors 306 may include a sensor to sense an individual's use of a furniture item 130. For example, when configured as a lounge chair, a furniture item 130 may incorporate a pressure sensor (transducer) to sense the weight of a person on a surface of the furniture item 130. Alternatively, an optical system may be used to detect use of a furniture item 130. For example, an optical emitter may be incorporated into one section (e.g., arm, back support, etc.) of a furniture item 130 and an optical detector, which is configured to detect light emitted by the optical emitter, may be incorporated into another section (e.g., arm, back support, etc.) of the furniture item 130. In this configuration, use of the furniture item 130 may be detected when the optical detector detects an interruption in the light emitted by the optical emitter when a user occupies the furniture item 130 (e.g., when a user sits between the arms of the lounge chair).

In aspects, the processing device 300 may include one or more processors. The processing device 300 may receive input from and/or provide output to the communication unit 302, the user interface 304, the one or more sensors 306, and/or the GPS module 308. The processing device 300 may execute one or more of a location determination module 320, a notification module 322, a reservation confirmation module 324, and/or a furniture item state determination module 326.

In aspects, the location determination module 320 is configured to determine the positions or locations of the furniture items 130 according to one or more of the methods described herein.

In aspects, the notification module 322 is configured to notify a user of the status of a furniture item 130, e.g., that the furniture item 130 is reserved, or the furniture item 130 is occupied. The notification module 322 may interface with a display screen, e.g., an LCD screen, or one or more indicators, e.g., a multicolored LED, and may control the display screen or the one or more indicators to indicate to an individual the current status of a furniture item 130.

In aspects, the reservation confirmation module 324 is configured to manage reservations made by users. Users may run a software application on their devices, which displays current reservations, e.g., by graying out representations of furniture item 130 on a map displayed by the software application and prompts the user to provide input that creates a reservation for the user.

In aspects, the furniture item state determination module 326 is configured to determine the current state of a furniture item 130. For example, the furniture item state determining module 326 determines whether a furniture item 130 is in use. This may include determining whether a sensor on a furniture item 130 indicates that a person is occupying (e.g., sitting in) or otherwise use the furniture item 130. The sensor may be a weight sensor (e.g., a pressure transducer) or an optical sensor.

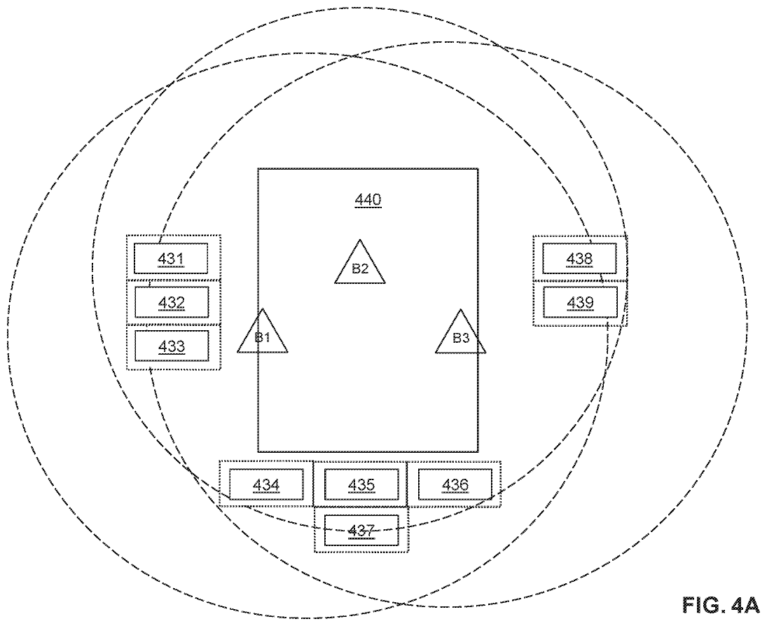

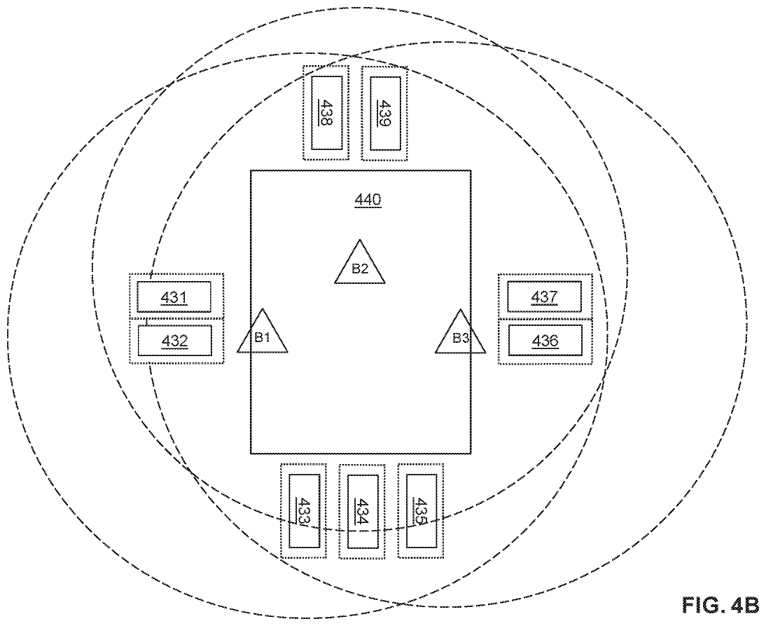

FIGS. 4A and 4B illustrate an example of location maps of an area, e.g., a seating area, generated at two different times. In this example, a set of furniture items 130 (e.g., lounge chairs or seats 431 . . . 439) is positioned with respect to a seating area, which may be a deck surrounding a swimming pool 440. In aspects, the systems and methods of this disclosure generate maps of furniture items 130 regardless of the configuration of the seating area or the arrangement of the furniture items 130, which may vary from period to period, e.g., from day to day or from time block to time block. For example, as illustrated in FIG. 4A, at the start of one period (e.g., a first and second day), lounge chairs 431-433 may be positioned on a first side of the pool 440 in a first orientation, lounge chairs 434-447 may be positioned on a second side of the pool 440 in the first orientation, and lounge chairs 438, 439 may be positioned on a third side of the pool 440 in the first orientation. Then, as illustrated in FIG. 4B, at the start of another period (e.g., a third day), lounge chairs 431, 432 may be positioned on the first side of the pool 440 in the first orientation, lounge chairs 434-446 may be positioned on the second side of the pool 440 in a second orientation, lounge chairs 436, 437 may be positioned on the third side of the pool 440 in the first orientation, and lounge chairs 438, 439 may be positioned on a fourth side of the pool 440 in the second orientation.

As described above, each furniture item 130 may include a control device 140 that communicates with one or more beacons B1, B2, B3. In this example, each control device 140 may determine the signal strength read from each respective beacon 140 (B1, B2, B3), which may be used to determine the respective location of each furniture item 130 431 . . . 439, for example, through a multilateration process. This information is then used to generate a map for use with a reservation system.

The map of furniture items 130 may be generated automatically. For example, at the beginning of each day or at any other regular or irregular time intervals suitable for capturing changes in the arrangement of furniture items 130, the backend system 110 may activate the control devices 140 and the beacon devices 160, obtain or access position information for all furniture items 130 in the area, and generate a map of the furniture items 130. Additionally, or alternatively, a person, such as a manager or other staff member, may manually cause the system to generate a map, e.g., by selecting a button in a management application running on the manager's or staff member's device, e.g., a laptop computer or tablet.

Referring back to FIG. 1, in some aspects, each backend system 140 may include a GPS device. In these aspects, the GPS device may output a position signal that indicates a geolocation (e.g., longitude and latitude) of the backend system 140. In these aspects, the backend system 140 may report its location to the backend device 110 may determine its location using the GPS device.

In aspects, the control devices 140 may output location signals (e.g., signal strengths, triangulated locations, and/or geolocations) to the backend system 110 periodically (e.g., every hour, every day, or the like). Additionally, or alternatively, the control devices 140 may be configured with motion sensors (e.g., accelerometers, and/or gyroscope), such that a control device 140 outputs the location signals upon detecting motion (e.g., greater than one meter of movement). The backend system 110 may update the location map of an area. In some of these aspects, the backend system 110 may have a layout that indicates the locations of points of interest (e.g., pool, beach, bar, restaurant, structures, restrooms, or the like). The layout may include seating areas (e.g., areas where furniture items 130 may be located).

The backend system 110 may update the location of each respective furniture item 130 (e.g., a furniture item 130 ID) with respect to a location or zone within the layout. In these aspects, the location map may then include locations of furniture items 130, and for each furniture item 130 location, a furniture item 130 ID (or other suitable indicia) of the corresponding furniture item 130. In this way, the location map can be presented to a user to illustrate locations of available furniture items 130, and the furniture item 130 ID (or other indicia) may be used by the backend system 110 to interface with an appropriate control device 140 (e.g., to send a message to a specific control device 140 to update its status to reserved status or available status or when an occupancy message is provided by a control device 140).

In aspects, the control devices 140 may include one or more sensors (e.g., weight sensors, pressure sensors, accelerometers, or the like). In some of these aspects, the control device 140 may utilize the sensors to determine whether a corresponding furniture item 130 is occupied. For example, when a weight or pressure above a certain threshold is detected by a respective sensor or if a detected motion profile is that of having someone occupy a furniture item 130, the control device 140 may transmit an occupancy message to the backend system 110 indicating that the furniture item 130 is occupied. Similarly, when the detected weight or pressure is no longer detected by the sensors, the control device 140 may transmit an occupancy message to the backend system 110 indicating that the furniture item 130 is no longer occupied.

The occupancy message may indicate a furniture item ID of the control device 140 and the occupancy status (e.g., that the furniture item 130 is occupied or unoccupied). In this way, the backend system 110 may determine when the furniture items 130 are in use and when the furniture items 130 are no longer in use. In aspects, the backend system 110 may update the location map with real-time occupancy data. In these aspects, the location map may include metadata that indicates the current status of a furniture item 130. For example, in some aspects, the status of a furniture item 130 may be “open/available”, “reserved and unoccupied”, “reserved and in use by reservation holder”, “reserved but not unlocked” and/or any other suitable statuses. In this example, the backend system 110 may determine that a furniture item 130 is open/available if the furniture item 130 is not currently reserved and not due to be reserved (e.g., at least one hour before a reservation) and the occupancy status of the furniture item 130 indicates that the seat is unoccupied (e.g., no occupancy messages have been received).

In another example, the backend system 110 may determine that a furniture item 130 is reserved and unoccupied when the reservation status of the furniture item 130 is currently reserved or due to be reserved (e.g., within an hour) and the occupancy status indicates that the furniture item 130 is empty. In another example, the backend system 110 may determine that a furniture item 130 is reserved and in use by the reservation holder (or “unlocked”) when the reservation status of the furniture item 130 is currently reserved or due to be reserved (e.g., within an hour) and the furniture item 130 has been unlocked by the reservation holder. In another example, the backend system 110 may determine that a furniture item 130 is reserved and in use by the reservation holder (or “unlocked”) when the reservation status of the furniture item 130 is currently reserved or due to be reserved (e.g., within an hour), the occupancy status of the furniture item 130 is occupied, and the furniture item 130 has not been unlocked by the reservation holder. The backend system 110 may update the status of each furniture item 130 in a location map based on the determined status of the furniture item 130. When the status changes (e.g., a reservation becomes due, the reservation ends, an object is detected, the object is no longer detected etc.), the backend system 110 can change the status of the furniture item 130.

In aspects, the backend system 110 may provide notifications to the control device 140 corresponding to a particular furniture item 130 (e.g., to indicate that the furniture item 130 is reserved, that the furniture item 130 is open, that the furniture item 130 is currently in use, unauthorized), and the control device 140 may update the visual indicia based on the received notifications (e.g., to alert an unauthorized user that they are improperly occupying or using a reserved furniture item 130).

In aspects, the backend system 110 may unlock a furniture item 130 for a reservation holder. In aspects, a reservation holding user can request that a reserved furniture item 130 be unlocked via the application 172. For example, the user can use the application to scan a QR-code that is associated with the control device 140, enter an unlocking code provided by the backend system 110 via a user interface of the control device 140, pair the user device 170 to the control device 140, or the like. Once a user has initiated the unlocking of a furniture item 130, the backend system 110 may verify the user and can send an unlocking notification to the control device 140. In response, the control device 140 may output a visual indicia indicating that the furniture item 130 is occupied for the duration of the reservation.

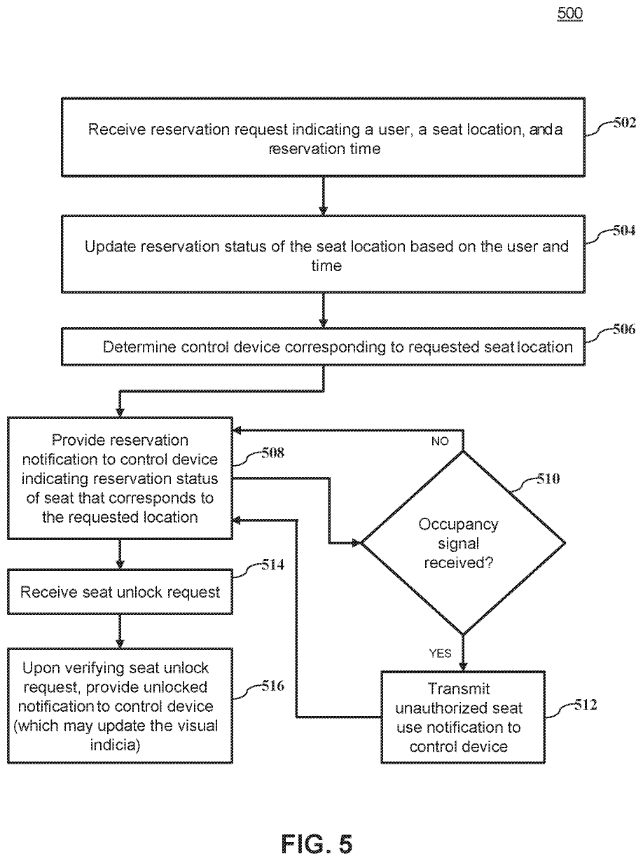

FIG. 5 is a flow diagram of a method 500 of managing use of furniture items 130 according to an aspect of this disclosure. At block 502, a reservation request indicating a user, a location of a furniture item 130, and a reservation time are received. The reservation requests may be received in response to providing or displaying a graphical user interface (GUI) to the user that presents a map and/or available locations or times, as shown, for example, in FIG. 12. At block 504, the reservation status of the location of the furniture item 130 is updated based on the user information and the time or time block. In aspects, a reservation record may be generated based on the user's reservation request. At block 506, the control device corresponding to the requested furniture item 130 location is determined. For example, the reservation system may access lookup table to determine the identification code of the control device so that the reservation system may communicate with the control device. At block 508, a reservation notification is provided to the control device indicating the reservation status of the furniture item 130 that corresponds to the requested location. Upon receiving the reservation notification, the control device may cause a message to be displayed on an LCD display of the furniture item 130 that the furniture item 130 is reserved (e.g., at a particular time).

At block 510, the method includes determining whether an occupancy signal is received. The occupancy signal may be generated by a sensor incorporated into the furniture items 130 that detects whether a person is occupying or otherwise using a particular furniture item 130. If an occupancy signal is not received, the method 500 returns to block 508. If an occupancy signal is received at block 510, an unauthorized use notification is transmitted to the control device at block 510 and the method 500 returns to block 508. Once an unlock request 514 is received by the backend system, for example, from a user device that is in the vicinity of the control device, the unlock request is verified and an unlocked notification is provided to the control device, which may update visual indicia to indicate that the furniture item 130 is in use. In other aspects, the loop of blocks 510 and 512 may be performed between blocks 506 and 508.

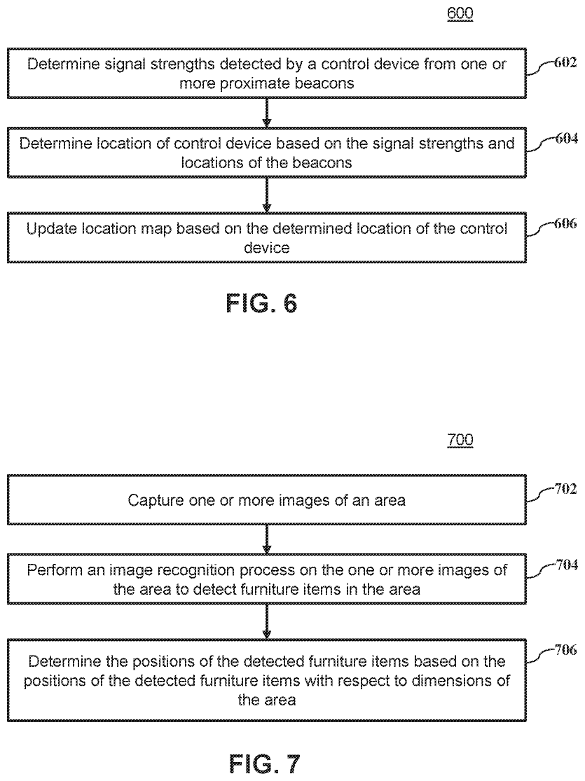

FIG. 6 is a flow diagram of a method 600 of determining locations of furniture items 130 according to an aspect of this disclosure. As described herein, the locations of the furniture items 130 may be determined at different times, e.g., every one or more days, to account for changes in the arrangement of furniture items 130 and/or the types of furniture items 130 that are placed in an area. At block 602, the signal strengths detected by a control device 140 from one or more proximate beacons B are determined. In an alternative aspect, the backend system obtains signal strengths from the one or more beacons B proximate to the control device 140, which transmits a position or location signal to the one or more beacons B. At block 604, a location map indicating the locations of all control devices 140 in the area is updated based on the determined location of the control devices 140 associated with each of the furniture items 130 positioned in the area.

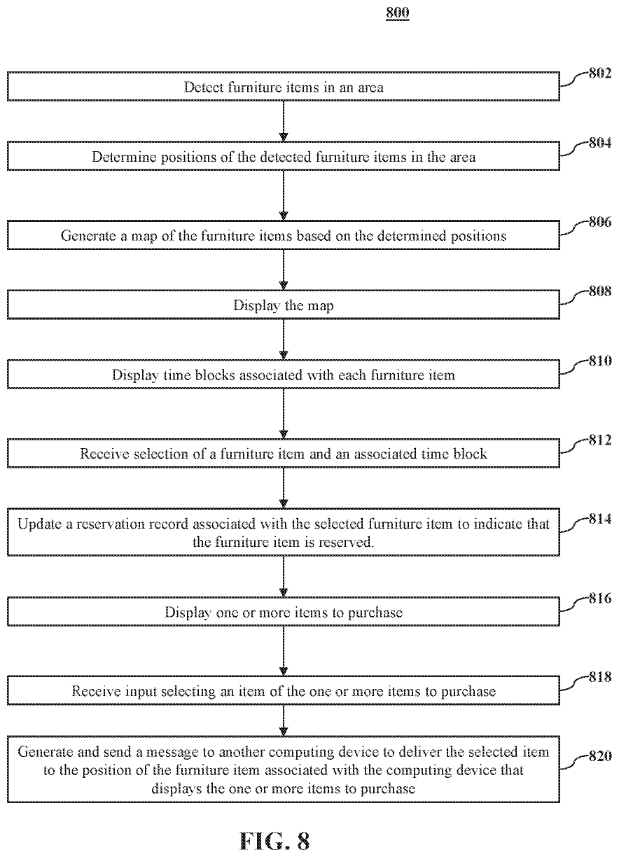

FIG. 7 is a flow diagram of a method 700 of determining locations of furniture items 130 according to another aspect of this disclosure. At block 702, one or more images of an area is captured by one or more image capturing devices, e.g., charge coupled device (CCD) cameras or complementary metal oxide semiconductor (CMOS) cameras. At block 704, an image recognition process is performed on the one or more images of the area to detect furniture items 130 in area. Then, at block 706, the positions of the detected furniture items 130 are determined based on the positions of the detected furniture items 130 with respect to the dimensions of the area.

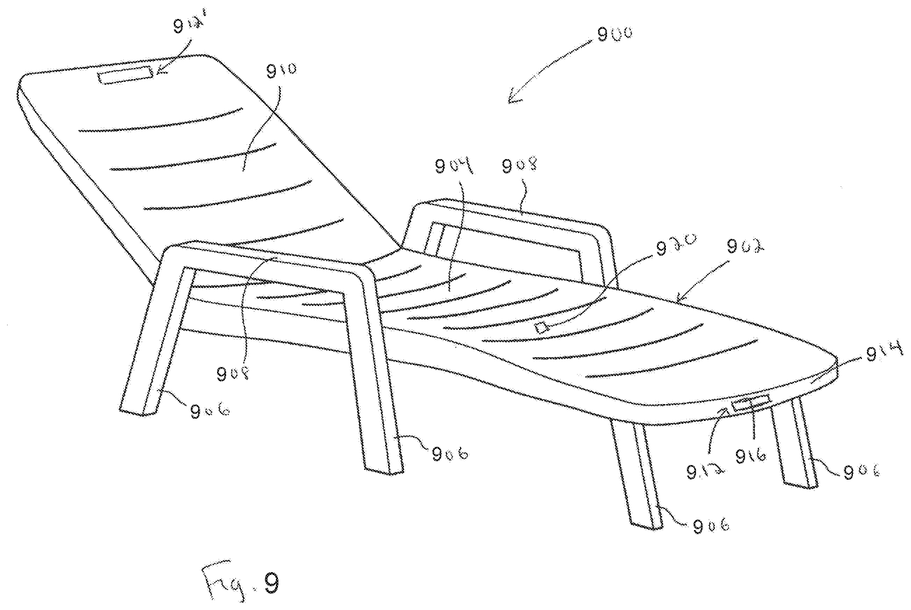

FIG. 8 is a flow diagram of a method 800 of managing use of furniture items 130 according to another aspect of this disclosure. At block 802, furniture items 130 are detected or identified in an area. At block 804, positions of the detected or identified furniture items 130 in the area are determined. For example, in response to requests from the backend system 110, the control devices 140 associated with each furniture item 130 may determine their position, by, for example, using a global positioning system (GPS) module 308 of the control device 140 or communicating with multiple beacons distributed throughout the area. In one aspect, the control device 140 may measure the strength of electromagnetic signals emitted from the multiple beacons, translate the measured strength of the electromagnetic signals into distance measurements between the control device 140 and each of the beacons, and determine the position of the control device 140 with respect to the beacons based on the distance measurements using, for example, a multilateration or trilateration process.

At block 806, a map of the furniture items 130 is generated based on the determined positions. Blocks 802-806 may be repeated to update the map if additional furniture items 130 are added to the area during a particular day. For example, if all furniture items 130 in an area are in use and there is room for additional furniture items 130, a manager or a manager's staff may place additional furniture items 130 in the area. Blocks 802-806 may then be repeated to detect the additional furniture items 130, to determine the positions of the additional furniture items 130, and to update the map to include the additional furniture items 130 based on the determined positions.

At block 808, the map is displayed, for example, on a user device. At block 810, time blocks associated with each furniture item 130 is also displayed. It is envisioned that the time blocks may be divided into any suitable or desirable increments. For example, the time blocks may represent an entire day or series of days, hours, etc. At block 812, selection of a furniture item 130 and associated time block is received. At block 814, a reservation record associated with the selected furniture item 130 is updated to indicate that the furniture item 130 is reserved. At block 816, one or more items to purchased are displayed, for example, on the user device. At block 818, user input selecting an item of the one or more items to purchased is received. Then, at block 820, a message is generated and sent to another computing device to deliver the selected item to the position of the furniture item 130 associated with the computing device that displays the one or more items to purchase.

It is also envisioned that the time blocks may be eliminated in certain aspects of the disclosure and that each reservation may be fixed in duration. For example, each reservation may be confined to a 12- or 24-hour period such that each reservation spans a 12- or 24-hour window of time.

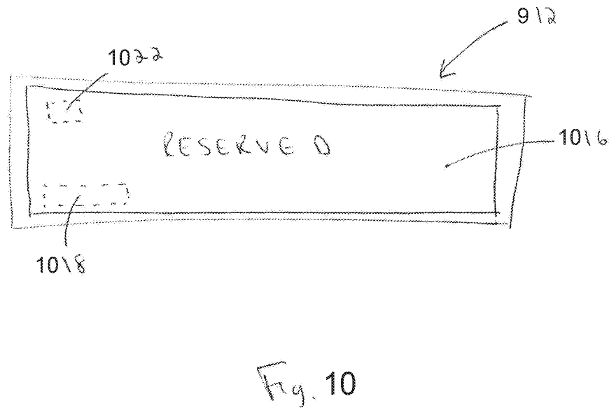

With reference now to FIGS. 9-12, an aspect is illustrated in which the furniture item 130 is configured as a lounge chair 900. The lounge chair 900 includes a body 902, which may include a seating surface 904, a plurality of legs (or feet) 906, arms 908, and a back rest 910, which may be either fixed or adjustable. The lounge chair 900 also includes a module 912 (e.g., the aforementioned control device 140) that identifies the lounge chair 900 as being either available or reserved. Although shown as including a single module 912 positioned on a front surface 914 of the body 902, it should be appreciated that the number of modules 912 and/or the location of the modules 912 may be varied in alternate aspects of the disclosure. For example, the lounge chair 900 may include a module 912′ positioned on the back rest 910, either in addition to, or instead of, the module 912.

In one particular aspect, it is envisioned that the module 912 may include a screen 916 that can be used to identify the status of the lounge chair 900. For example, the screen 916 (also referred to as a “display” or “visual indicator”) may display the word “available” or the word “reserved.” Additionally, or alternatively, the screen 916 may use color to identify the status of the lounge chair 900. For example, the screen 916 may be green when the lounge chair 900 is available and may turn red when the lounge chair 900 is reserved. Additionally, or alternatively, it is envisioned that the screen 916 may display information particular to the reserving individual, such as a code (whether numerical or otherwise), the reserving individual's name, the reserving individual's room or account number, etc.

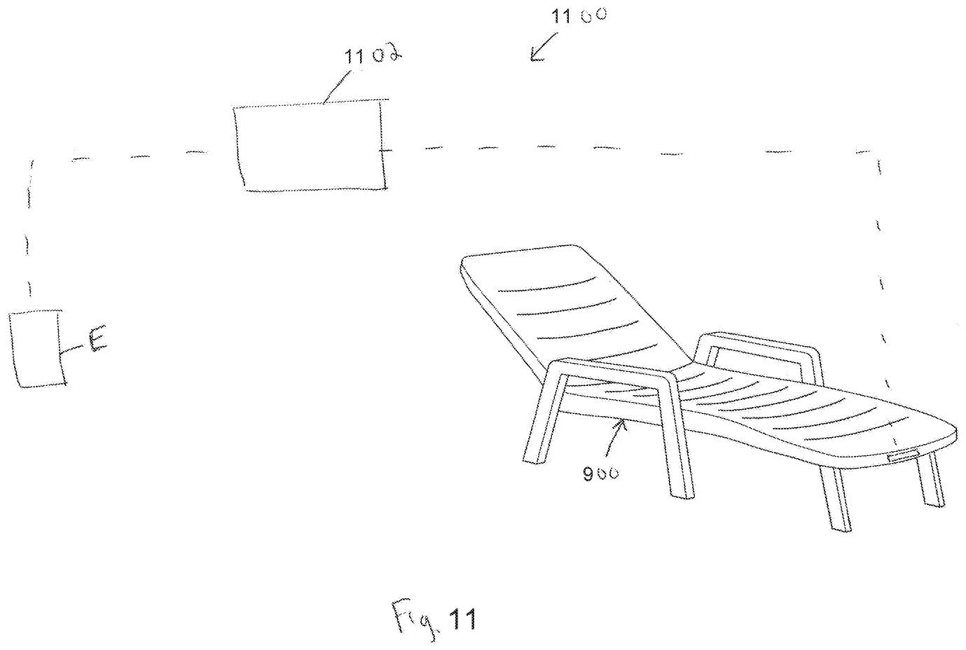

The lounge chair 900 and/or the module 912 may be powered in any suitable manner. For example, the lounge chair 900 and/or the module 912 may be powered by solar energy or may include (or may otherwise be connected to) a power source 1018 (FIG. 10), such as a battery.

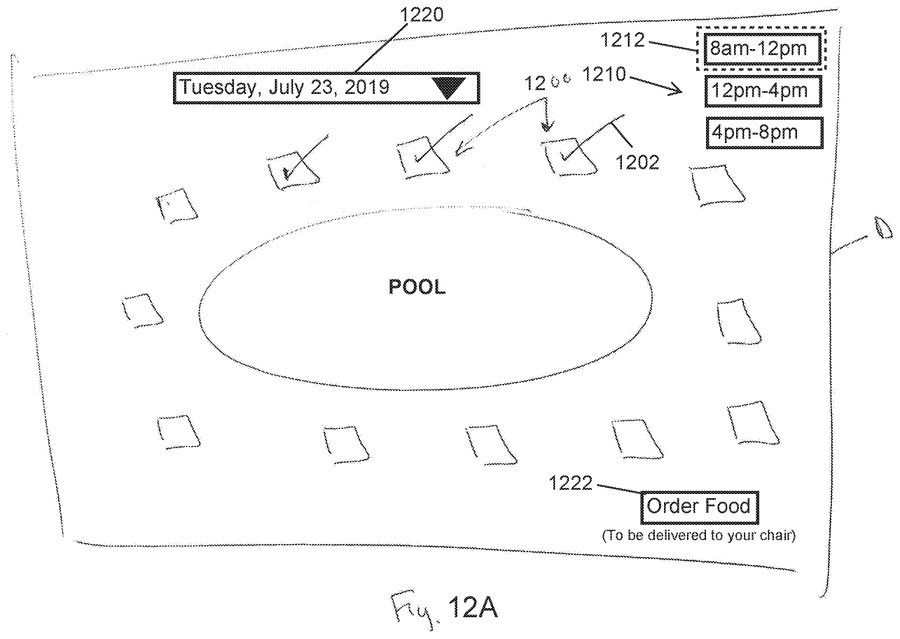

As seen in FIG. 11, this disclosure also describes a system 1100 that supports the remote reservation of one or more lounge chairs 900 in that individuals do not need to be physically present at the lounge chair 900 to reserve the lounge chair 900. For example, currently, individuals must wake early in order to physically place a personal item or other such article on the lounge chair(s) 900 they wish to reserve. The system 1100, however, allows individuals to reserve the lounge chair(s) 900 without physically being present. The system 1100 provides a platform that allows individuals to view the lounge chair(s) 900 present in a particular area (e.g., adjacent a pool) and select one or more lounge chair(s) 900 for reservation. Once selected, the system 1100 identifies the chosen lounge chair(s) as “reserved” to prevent multiple individuals from reserving the same lounge chair(s), and a signal is communicated to the module 912 to identify the lounge chair(s) 900 as such.

When supported by an interactive platform, such as a website or an application on an electronic device E (FIG. 11) (e.g., a smartphone or the like), the system 1100 may display which lounge chair(s) 900 are available for reservation and which lounge chairs are unavailable for reservation (e.g., which lounge chair(s) 900 have already been reserved). For example, FIG. 12 illustrates a display D (e.g., on a user's electronic device) representative of a series of lounge chairs 1200 positioned around a pool, of which three are identified as being reserved using checkmarks 1202. Alternatively, the lounge chairs may be shown as being reserved by filling the shapes representing the lounge chairs with a color, e.g., gray or black. The display D may also include buttons 1210 that may be selected one at a time to switch between displaying reservations at different times. The display D may show the time block that is selected by displaying a dashed box 1212 around the currently selected button. The display D also includes a pull-down menu for selecting a day on which to reserve a furniture item 130. The display D may also include a button 1222 for ordering food, which, when selected, causes another screen to be displayed so that the user can order food. When the food order is processed, the location of the users lounge chair 900 is provided to a computing device of a food service so that a delivery person associated with the food service can deliver the food to the user's lounge chair. 900 It is envisioned that the system 1100 may be wirelessly accessed via the internet or other such suitable connection, network, or the like.

It is envisioned that reservations may be made in predetermined intervals of time (e.g., 4 to 8-hour blocks of time). Alternatively, it is envisioned that an individual may identify and input a duration for their reservation. For example, a user may identify to the system 1100 that they wish to reserve the lounge chair(s) 900 from 6:00 am to 1:00 pm only.

This disclosure contemplates various mechanisms and methods by which the lounge chair(s) 900 may be returned to an availability pool (i.e., to the group or list of unreserved lounge chair(s) 900). For example, it is envisioned that a user may actively and voluntarily surrender the lounge chair(s) 900 when they no longer have any use for the reservation. For example, a user may manually select a button in or provide other suitable input to a reservation application running on the user device 170 to surrender the lounge chairs(s) 900. The reservation application may then communicate this information with the backend system 110 (e.g., a server), which may update the reservation status of the lounge chair(s) 900 to “available”. Additionally, or alternatively, the lounge chair(s) 900 may be passively returned to the availability pool. For example, the lounge chair(s) 900 may be automatically returned the availability pool (i.e., without any action on the part of the user) after a period of non-use (e.g., 60 minutes), and may be identified as such (e.g., on the website or on the application). To identify non-use, it is envisioned that the lounge chair(s) 900 may include one or more sensors 920 (FIG. 9) capable of identifying whether the user is physically present in the lounge chair 900 (e.g., a weight sensor, a capacitive detector, an infrared sensor, a photoelectric cell, etc.).

Additionally, or alternatively, it is envisioned that the lounge chair(s) 900 (e.g., the module 912) may include a proximity mechanism 922 to ascertain whether the user is in the vicinity of the lounge chair(s) 900. In one aspect, it is envisioned that the lounge chair(s) 900 (e.g., the module 912) may be in continuous or periodic contact with the user via signal transmission. For example, one or more signals may be communicated between the module 912 and a user's electronic device E (FIG. 11) (e.g., cell phone), the user's access card, badge, (e.g., the user's room key), etc. to determine whether the user (or the user's electronic device, access card, etc.) is within a predetermined threshold range (e.g., 300 feet). If it is determined that the user (or the user's electronic device, access card, etc.) is within the threshold range, no action may be taken, and the reservation may continue uninterrupted.

If, however, it is determined that the user (or the user's electronic device, access card, etc.) is outside the threshold range, the lounge chair 900 may immediately be surrendered and returned to the availability pool. Alternatively, if it is determined that the user (or the user's electronic device, access card, etc.) is outside the threshold range, a timer may be started. If the user (or the user's electronic device, access card, etc.) returns and is again present (i.e., within the threshold range) within a predetermined amount of time (e.g., 30 to 60 minutes), the reservation may continue. If the predetermined amount of time lapses, however, the lounge chair 900 may be surrendered and returned to the availability pool. Additionally, or alternatively, when it is determined that the user is outside the threshold range, it is envisioned that the system 1100 may generate a prompt (e.g., a text message, SMS, email, etc.) asking the user if they wish to continue the reservation, at which time, the user may indicate that they wish to continue the reservation, or that they do not wish to continue the reservation and instead wish to surrender the lounge chair 900 so that it can be returned to the availability pool. It is also envisioned that, upon generating the prompt, a timer may be started providing the user with a predetermined amount of time (e.g., 10 minutes) to respond. In the event that the user is non-responsive to the prompt, the reservation may be canceled and the lounge chair 900 may be returned to the availability pool.

In the event that a reservation is canceled by the system 1100 (e.g., due to non-use or a user's failure to respond to the aforementioned prompt), it is envisioned that the system 1100 may generate an alert for distribution to onsite staff such that any personal belongings on, near, or adjacent the lounge chair 900 may be collected and stored on behalf of the surrendering user for collection at a later time.

In the event that a user wishes to reserve one or more lounge chair(s) 900 that are already reserved (e.g., due to the desirability of their location), it is envisioned that the system 1100 may support a queue for the one or more lounge chair(s) 900, and that they system 1100 may alert the user when the lounge chair 900 becomes available (e.g., via email, text message, SMS, etc.). For example, in the event that a reservation is canceled or surrendered, or in the event that a reservation is terminated by the system 1100 (e.g. for non-use), the system 1100 may alert the user(s) in the queue in sequential order (i.e., in accordance with the order in which the users enter the queue) such that the users in the queue may reserve the lounge chair(s) 900.

It is envisioned that the system 1100 may include any architecture or components suitable for the intended purpose of supporting the functionality described above.

Although described above as being incorporated into the one or more lounge chairs 900, as mentioned above, it is also envisioned that the module 912 may be a stand-alone unit that can be connected to (or otherwise associated with) an existing lounge chair. For example, the module 912 may include a housing (e.g., a bracket) that can be secured to the lounge chair L in any suitable location using one or more fasteners (e.g., screws), an adhesive, zip-ties, etc. In such aspects, it is envisioned that the aforementioned power source 1018 may be incorporated into the module 912. Additionally, or alternatively, it is envisioned that the module 912 may be powered by solar energy, as discussed above.

While several aspects of the disclosure have been shown in the drawings, it is not intended that the disclosure be limited thereto, as it is intended that the disclosure be as broad in scope as the art will allow and that the specification be read likewise. Therefore, the above description should not be construed as limiting, but merely as exemplifications of particular aspects.

Persons skilled in the art will understand that the various aspect of the disclosure described herein and shown in the accompanying figures constitute non-limiting examples, and that additional components and features may be added to any of the aspect described herein without departing from the scope of the present disclosure. Additionally, persons skilled in the art will understand that the elements and features shown or described in connection with one aspect may be combined with those of another aspect without departing from the scope of the present disclosure and will appreciate further features and advantages of the presently disclosed subject matter based on the description provided. Variations, combinations, and/or modifications to any of the aspects and/or features of the aspects described herein that are within the abilities of a person having ordinary skill in the art are also within the scope of the disclosure, as are alternative aspects that may result from combining, integrating, and/or omitting features from any of the disclosed aspects.

Use of the term “optionally” with respect to any element of a claim means that the element may be included or omitted, with both alternatives being within the scope of the claim. Additionally, use of broader terms, such as “comprises,” “includes,” and “having,” should be understood to provide support for narrower terms, such as “consisting of,” “consisting essentially of,” and “comprised substantially of.”Accordingly, the scope of protection is not limited by the description set out above but is defined by the claims that follow and includes all equivalents of the subject matter of the claims.

In the preceding description, reference may be made to the spatial relationship between the various structures illustrated in the accompanying drawings, and to the spatial orientation of the structures. However, as will be recognized by those skilled in the art after a complete reading of this disclosure, the structures described herein may be positioned and oriented in any manner suitable for their intended purpose. Thus, the use of terms such as “above,” “below,” “upper,” “lower,” “inner,” “outer,” “left,” “right,” “upward,” “downward,” “inward,” “outward,” etc., should be understood to describe a relative relationship between the structures and/or a spatial orientation of the structures. Those skilled in the art will also recognize that the use of such terms may be provided in the context of the illustrations provided by the corresponding figure(s).

Additionally, terms such as “approximately,” “generally,” “substantially,” and the like should be understood to allow for variations in any numerical range or concept with which they are associated. For example, it is intended that the use of terms such as “approximately” and “generally” should be understood to encompass variations on the order of 25%, or to allow for manufacturing tolerances and/or deviations in design.

Each and every claim is incorporated as further disclosure into the specification and represents aspects of the present disclosure. Also, the phrases “at least one of A, B, and C” and “A and/or B and/or C” should each be interpreted to include only A, only B, only C, or any combination of A, B, and C.

What is claimed is:

1. A method of managing use of a plurality of furniture items in an area, the method comprising:
generating a map of a plurality of furniture items based on determined physical position information of the plurality of furniture items in the area;
displaying the map;
receiving a request to reserve one or more of the plurality of furniture items;
setting status information in a reservation record associated with the one or more furniture items to a reserved status; and
indicating, by an electronic device at the one or more furniture items, the reserved status.

2. The method of claim 1, further comprising:
determining that a furniture item is not physically located at the furniture item's position on the map; and
in response to determining that a furniture item is not located at the furniture item's position on the map, transmitting a message to a manager device indicating that the furniture item is not located at the furniture item's position on the map.

3. The method of claim 1, further comprising:
detecting one or more additional furniture items in the area; and
updating the map to reflect the one or more additional furniture items based on determined physical position information of the one or more additional furniture items.

4. The method of claim 1, further comprising:
displaying input controls to purchase one or more items at a first computing device used to request reservation of a furniture item;
receiving input for the purchase of an item of the one or more items at the first computing device; and
transmitting a message to a second computing device to deliver the purchased item to the furniture item associated with the first computing device.

5. The method of claim 1, further comprising:
detecting that a furniture item is being used by a person;
in response to detecting that a furniture item is being used by a user, retrieving reservation information for the furniture item at a current time and determining that a tag of the user is not associated with the reservation information; and
in response to determining that the tag of the user is not associated with the reservation information, transmitting a message that the user is an unauthorized user.

6. The method of claim 5, further comprising:
transmitting an unauthorized seat use notification to an electronic device of the furniture item; and
controlling, by the electronic device, visual indicia to indicate that there is unauthorized seat use.

7. The method of claim 1, further comprising:
causing the electronic device associated with each of the plurality of furniture items to determine the physical position of the electronic device; and
receiving physical position information including the physical position of the control device associated with each of the plurality of furniture items.

8. The method of claim 1, further comprising:
determining that a reservation of a furniture item is cancelled;
in response to determining that a reservation of a furniture item is cancelled, transmitting a furniture item unlock message to an electronic device of the furniture item;
receiving, by the electronic device, a furniture item unlock message;
in response to receiving a furniture item unlock message, indicating, by the electronic device, an unlocked status notification on a notification device of the furniture item; and
setting the status information in the reservation record associated with the one or more furniture items to an available status.

9. The method of claim 8, wherein the notification device is a display device, and
wherein the electronic device displays a visual indicia of the unlocked status notification on the display device.

10. The method of claim 1, wherein generating a map of the plurality of furniture items includes generating a map of a plurality of lounge chairs, seats, tables, food and beverage holders, umbrellas, cabanas, or any combination thereof.

11. The method of claim 1, further including:
measuring, by a plurality of receivers, signal characteristics of a position signal, which is transmitted by the electronic device of a corresponding furniture item; and
determining a position of the furniture item corresponding to the electronic device based on the measured signal characteristics and locations of the plurality of receivers.

12. The method of claim 1, further comprising:
capturing an image of the area;
executing an image recognition process on the image of the area to detect the plurality of furniture items in the area; and
determining the plurality of positions of the detected plurality of furniture items, respectively, based on a result of executing the image recognition process.

13. The method of claim 1, further comprising:
displaying a cost associated with an available time block for using a furniture item;
determining an amount of time between a current time and the available time blocks;
determining that the amount of time is less than a threshold; and
in response to determining that the amount of time is less than the threshold, decreasing the cost associated with the available time block for using the furniture item.

14. The method of claim 1, further comprising:
determining that a furniture item is in use by a person;
in response to determining that the furniture item is in use, determining that the furniture item is not reserved at a current time; and
in response to determining that the furniture item is not reserved at the current time, creating a reservation of the furniture item for the person.

15. A method of reserving use of a furniture item, the method comprising:
displaying a map of a plurality of furniture items generated based on a determined plurality of physical positions of a plurality of furniture items;
receiving a selection of a furniture item from the plurality of furniture items to reserve the furniture item; and
transmitting information regarding reservation of the furniture item by a user to a reservation server, which causes a control device incorporated into the furniture item to display a reserved status of the furniture item.

16. The method of claim 15, further comprising:
receiving input for the purchase of an item of the one or more items; and
transmitting a message to a remote device to deliver the purchased item to the physical position of the reserved furniture item.

17. A system for managing use of a plurality of furniture items in an area, the system comprising:
a plurality of furniture item communication devices and a plurality of electronic devices disposed on a plurality of furniture items, respectively, in the area, the electronic devices configured to indicate a status of the respective plurality of furniture items;
a plurality of beacons distributed throughout the area, each of the plurality of beacons being configured to receive a position signal from each of the plurality of furniture item communication devices, respectively; and
a server in communication with the plurality of beacons, the server comprising a processor and a memory storing instructions, which, when executed by the processor, causes the server to:
determine a plurality of positions of the plurality of furniture items, respectively, in the area based on the plurality of position signals;
generate a map of the plurality of furniture items based on the determined plurality of positions;
transmit the map and current reservation information to a user device; and
receive updated reservation information from the user device,
wherein the server causes one or more electronic devices of one or more respective furniture items to indicate that the one or more furniture items are reserved.

18. The system of claim 17, wherein the current reservation information includes furniture items that are currently used and furniture items that are reserved.

19. The system of claim 17, further comprising a furniture sensor disposed on each furniture item of the plurality of furniture items, the furniture sensor being configured to sense that a person is not using the corresponding furniture item and, in response to sensing that a person is not using the corresponding furniture item, transmit a nonuse signal to the server,
wherein the memory includes instructions, which, when executed by the processor, further cause the server to:
determine that the nonuse signal is received for greater than a predetermined period; and
in response to determining that the nonuse signal is received for greater than a predetermined period, cancel the reservation associated with the furniture item corresponding to the furniture sensor transmitting the nonuse signal.

20. The system of claim 17, wherein the memory includes instructions, which, when executed by the processor, further cause the server to:
receive an order to purchase one or more items from a first client device;
process the order; and
determine the furniture item associated with the first client device and transmit a message including the position of the furniture item to a second client device.
